(19) United States
(12) Patent Application Publication
(10) Pub. No.: US 2026/0346342 A1
(43) Pub. Date: Nov. 5, 2026

(54) ROTARY POWER TOOL WITH CLUTCH EVENT DETECTION

(71) Applicant: Milwaukee Electric Tool Corporation, Brookfield, WI (US)

(72) Inventors: Joseph W. Miller, Waukesha, WI (US); Brennan B. O'Gorman, Brookfield, WI (US); Julia C. Marsh, Milwaukee, WI (US); Ryan A. Bents, Brookfield, WI (US); Evan Glanzer, Brookfield, WI (US); Jacob Strachan, Brookfield, WI (US)

(21) Appl. No.: 19/666,507

(22) Filed: May 4, 2026

Related U.S. Application Data
(60) Provisional application No. 63/799,084, filed on May 2, 2025.

(51) Int. Cl. B23B 45/00; B23B 51/04

(52) U.S. Cl. CPC B23B 45/008; B23B 51/042

(57) ABSTRACT

A power tool includes a motor with a motor output shaft, a spindle driven by the motor output shaft to rotate about an axis, and a clutch mechanism positioned between the motor and a distal end of the spindle. The clutch mechanism is to execute a clutching event to limit an amount of torque transmitted from the motor output shaft to the spindle when the torque reaches a torque threshold. The power tool further includes a sensor that detects an acceleration of the power tool and a controller. The controller is to control a speed of the motor, obtain acceleration inputs from the sensor, detect the clutch mechanism executing the clutching event using the acceleration inputs, a power of the motor, and the speed of the motor, and reduce the speed of the motor when the clutching event is detected.

### RELATED APPLICATIONS

This application claims priority under 35 U.S.C. § 119 to United States Provisional Patent Application No. 63/799,084 filed on May 2, 2025, the entire contents of which is incorporated herein by reference.

### BACKGROUND

Clutch mechanisms in rotary power tools translate rotary motion of a motor into rotary motion of an output shaft of the tool. Such clutch mechanisms either slip at a fixed predetermined setting or an adjustable setting to limit the amount of torque from the motor that is transmitted to the output shaft.

### SUMMARY

In accordance with some embodiments, a power tool includes a motor with a motor output shaft, a spindle driven by the motor output shaft to rotate about an axis, and a clutch mechanism positioned between the motor and a distal end of the spindle. The clutch mechanism is to execute a clutching event to limit an amount of torque transmitted from the motor output shaft to the spindle when the torque reaches a torque threshold. The power tool further includes a sensor that detects an acceleration of the power tool and a controller. The controller is to control a speed of the motor, obtain acceleration inputs from the sensor, detect the clutch mechanism executing the clutching event using the acceleration inputs, a power of the motor, and the speed of the motor, and reduce the speed of the motor when the clutching event is detected.

In accordance with some embodiments, a method of operating a power tool is provided. The method includes operating a motor of the power tool at an operating speed, obtaining sensor inputs from an acceleration sensor located within the power tool, and determining when a mechanical clutch mechanism of the power tool is executing a clutching event based on the sensor inputs. The method further includes operating the motor of the power tool at a reduced speed below the operating speed when the mechanical clutch mechanism of the power tool is executing the clutching event.

In accordance with some embodiments, a power tool includes a motor with a motor output shaft, a spindle driven by the motor output shaft to rotate about an axis, and a clutch mechanism positioned between the motor and a distal end of the spindle. The clutch mechanism is to execute a clutching event to limit an amount of torque transmitted from the motor output shaft to the spindle when the torque reaches a torque threshold. The power tool further includes a controller to detect the clutch mechanism executing the clutching event and transmit a clutch event signal to an accessory in communication with the controller to deactivate the accessory.

In accordance with some embodiments, a method of operating a power tool is provided. The method includes operating a motor of the power tool, detecting a clutching event of a mechanical clutch mechanism of the power tool, and deactivating a water valve assembly to stop a flow of water to a drill bit coupled to a spindle of the power tool when the clutching event is detected.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is an isometric view of a core drill according to some embodiments.

FIG. 2 is a cross-sectional view of the core drill of FIG. 1, taken along line 2-2 of FIG. 1.

FIG. 3 is a plan view of an example rotary power tool with its housing removed, illustrating a clutch mechanism in accordance with some embodiments.

FIG. 4 is an exploded view of the clutch mechanism of FIG. 3.

FIG. 5 is a plan view of the clutch mechanism of FIG. 3.

FIG. 6 is a plan view of an outer ring of the clutch mechanism of FIG. 3.

FIGS. 7A-7E are various views of additional clutch mechanisms that may be incorporated into a power tool of some embodiments.

FIG. 8 is a partial cross-sectional view of a power tool according to some embodiments.

FIG. 9 is a schematic view of the power tool of FIG. 8.

FIG. 10 is an isometric view of a printed circuit board assembly of the power tool of FIG. 8.

FIG. 11 is a side view of the power tool of FIG. 8, illustrating reference axes.

FIG. 12 is an example flow diagram of operation of the power tool of FIG. 8 according to some embodiments.

FIG. 13 is a flow chart of an example method of detecting a clutch event according to some embodiments.

FIG. 14 is a graph of motor speed versus time during clutch event detection of a power tool according to some embodiments.

FIG. 15 is a partial internal view of a core drill including a water valve assembly according to some embodiments.

FIG. 16 is a close-up internal view of the water valve assembly of FIG. 15.

FIG. 17 is an example flow diagram of operation of the power tool of FIG. 15 according to some embodiments.

FIG. 18 is a schematic view of a power tool according to some embodiments in communication with external accessories.

### DETAILED DESCRIPTION

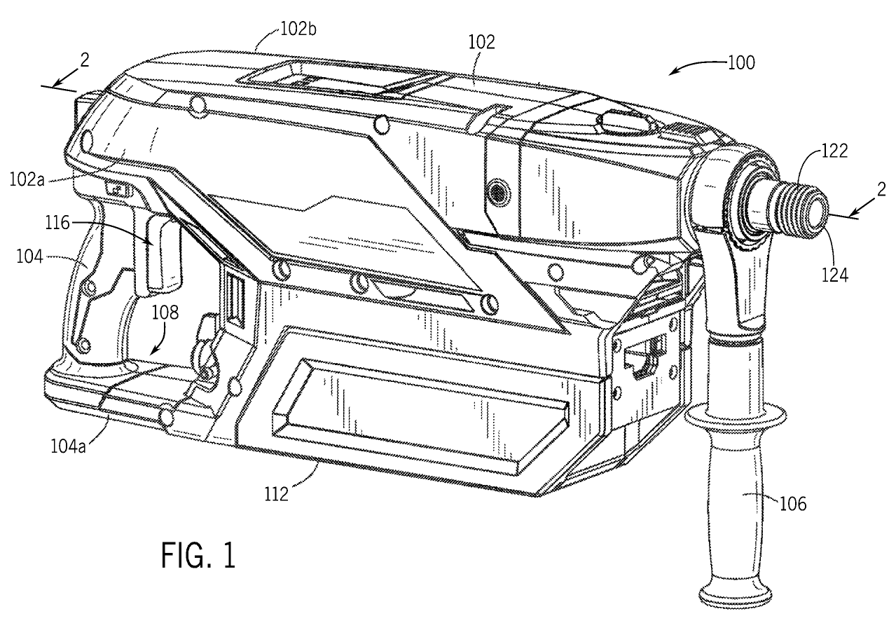

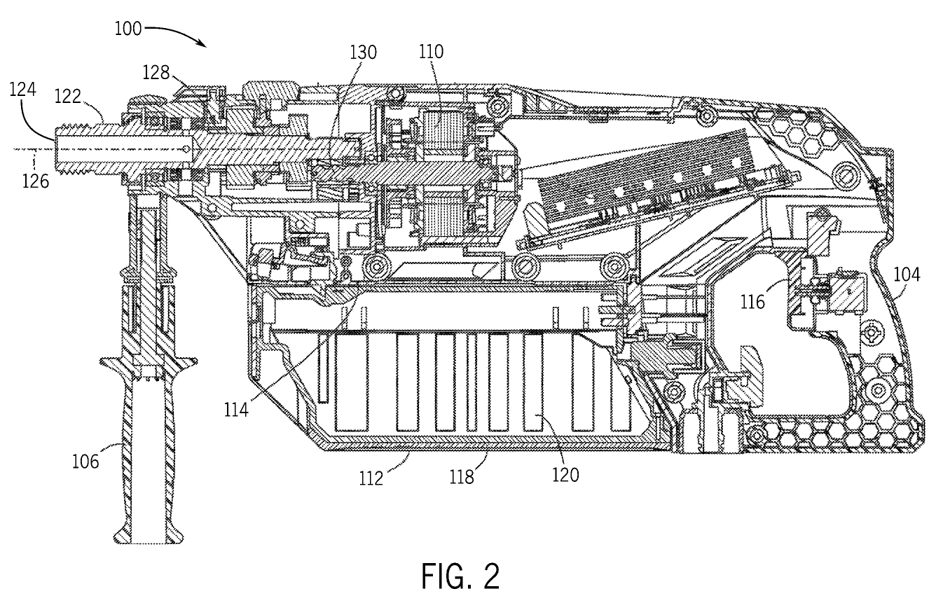

FIGS. 1 and 2 illustrate an example rotary power tool in the form of a core drill 100. The core drill 100 includes a housing 102, a first or rear handle 104, and a second or auxiliary handle 106. A generally D-shaped gap 108 is defined between the rear handle 104 and the housing 102. The gap 108 provides clearance for a user’s fingers when the user grasps the rear handle 104. In the illustrated embodiment, the rear handle 104 includes a base portion 104a at its lower end that extends to the housing 102. As such, the gap 108 is an aperture that is fully bounded about its perimeter by the rear handle 104, the base portion 104a, and the housing 102. In other embodiments, the base portion 104a may not connect to the housing 102.

In some embodiments, as shown in FIG. 1, the housing 102 may include a clamshell housing having left and right cooperating halves 102a, 102b. As shown in FIG. 2, an electric motor 110 is mounted within the housing 102, such as mounted directly to the housing 102 or within a separate motor housing (not shown) coupled to the housing 102. In the illustrated embodiment, the motor 110 is a brushless direct current motor; however, in other embodiments, the core drill 100 may include other types of motors. The illustrated core drill 100 is cordless and includes a battery 112 that provides power to the motor 110. The battery 112 is removably coupled to a battery receptacle 114, which is located underneath the motor 110 in the illustrated embodiment. In other embodiments, the core drill 100 may be a corded tool configured to receive power from a wall outlet or other remote power source. A trigger 116 is provided on the rear handle 104 and energizes the motor 110 when depressed by a user.

With continued reference to FIG. 2, the battery 112 is a power tool battery pack and includes a battery housing 118 and a plurality of rechargeable battery cells 120 disposed within the housing 118. The battery cells 120 are preferably lithium-based battery cells but can alternatively have any other suitable chemistry. In the illustrated embodiment, the battery 112 has a nominal output voltage of about 80V. In other embodiments, the battery 112 can have a different nominal voltage, such as, for example, 12V, 18V, 20V, 36V, 40V, 72V, between about 12V and about 80V, or greater than 40V. In some embodiments, the core drill 100 may be a Milwaukee Tool® M18® Core Drill, which operates using an 18V battery, or an MX Core Drill, which operates using a 72V battery.

As shown in FIG. 2, the core drill 100 further includes a spindle 122 rotatable about a rotational axis 126 in response to receiving torque from the motor 110. A tool bit (not shown) can be coupled to the spindle 122 for co-rotation with the spindle 122 to perform work (e.g., drilling) on a workpiece. A drive assembly 128 is disposed within the housing 102 to transmit torque from an output shaft 130 of the motor 110 to the spindle 122. In some embodiments, the core drill 100 and, more specifically, the drive assembly 128, may include a clutch mechanism positioned between the motor 110 and a distal end 124 of the spindle 122.

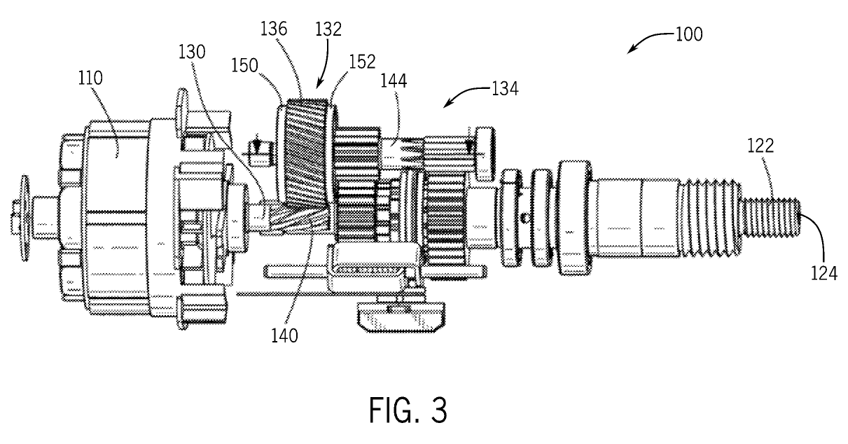

For example, FIG. 3 illustrates another example motor 110 and drive assembly 128 that may be incorporated into a rotary power tool, such as the core drill 100 of FIGS. 1 and 2. As shown in FIG. 3, the drive assembly 128 may include a clutch mechanism 132 positioned between the motor 110 and the distal end 124 of the spindle 122 to limit the amount of torque that can be transmitted from the motor 110 to the output spindle 122, and a transmission 134 positioned between the clutch mechanism 132 and the spindle 122. While the clutch mechanism 132 is illustrated between the transmission 134 and the motor 110 in FIG. 3, in some embodiments, the clutch mechanism 132 may instead be located along the spindle 122, e.g., between the transmission 134 and a bit (not shown) on the spindle 122.

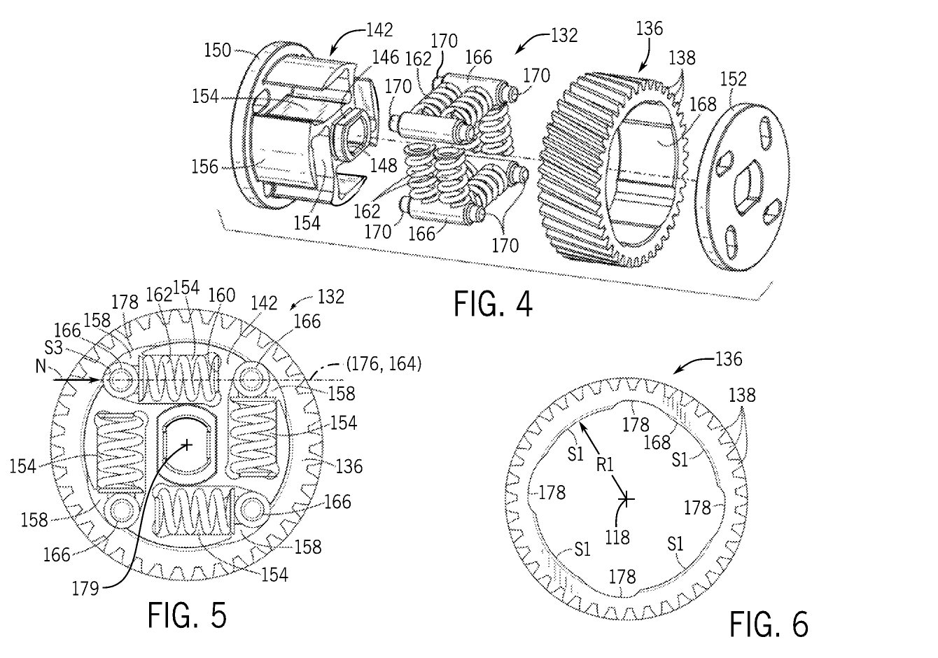

With further reference to FIG. 3, as well as FIGS. 4-6, the clutch mechanism 132 can include an input member or outer ring 136 having outer teeth 138 meshed with a pinion gear 140 which, in turn, is attached to the output shaft 130 of the motor 110. Because the outer ring 136 and the pinion gear 140 are continuously enmeshed, the outer ring 136 will rotate in response to rotation of the motor output shaft 130. The clutch mechanism 132 also includes an output member or clutch driver 142 coupled for co-rotation with an intermediate shaft 144 of the transmission 134. The clutch driver 142 includes a hub 146 defining therethrough a central aperture 148 in which a portion of the intermediate shaft 144 having a corresponding cross-sectional shape is received. The clutch driver 142 also includes a rear end cap 150 integrally formed as a single piece with the hub 146 and a front end cap 152 secured to the hub 146 (e.g., using an interference fit or another joining method). The outer ring 136 is axially constrained between the end caps 150, 152, such that the only degree of freedom between the outer ring 136 and the clutch driver 142 is rotation.

With reference to FIGS. 4 and 5, the clutch driver 142 can include multiple pockets 154 extending in an axial direction of the hub 146 between the end caps 150, 152. Each of the pockets 154 is positioned between the central aperture 148 and a cylindrical outer periphery 156 of the hub 146. The clutch mechanism 132 further includes at least one compression spring 162, such as a pair of two compression springs 162, within each pocket 154. One end of each of the springs 162 can be abutted against a base 160 of the pocket 154 in which the respective springs 162 reside, and an opposite end of each of the springs 162 protrudes from (or is at least proximate to) an opening 158 of the respective pockets 154. When positioned within the pockets 154, the respective longitudinal axes 164 of the springs 162 are oriented transverse to a rotational axis of the clutch driver 142.

With continued reference to FIGS. 4 and 5, the clutch mechanism 132 also includes a follower 166 disposed proximate the opening 158 of each pocket 154. Each follower 166 is biased outward by corresponding pairs of compression springs 162 against an interior surface 168 of the outer ring 136. Each of the followers 166 includes, on each side, a protruding portion 170 of a reduced diameter received within respective slots 172, 174 in the end caps 150, 152. When the followers 166 are displaced into the pockets 154 against the bias of the springs 162, the slots 172, 174 can constrain such displacement to be along a line of action parallel with the longitudinal axes 164 of the corresponding springs 162 with which the followers 166 are in contact.

Generally, as shown in FIGS. 5 and 6, the outer ring 136 can include cam surfaces 178 defined on the interior surface 168 thereof, associated with respective followers 166. That is, a respective follower 166 is in contact with the cam surface 178 during normal operation of the power tool 100 below a predetermined value of torque at which the clutch mechanism 132 slips. In the illustrated embodiment of the clutch mechanism 132, the cam surfaces 178 are defined by recesses, each of which is defined by a composite multi-radius arc. Adjacent each side of each of the cam surfaces 178, a segment S1 of the interior surface 168 of the outer ring 136 is defined by a minor radius R1 having an origin at the geometric center 180 of the outer ring 136. For purposes of illustration only, this geometric center 180 is shown by crosshairs in FIG. 6.

In operation of the power tool 100, an operator actuates a trigger 116 on the power tool 100 to drive the motor 110, causing the motor shaft 130 to rotate the outer ring 136. Below the predetermined value of torque at which the clutch mechanism 132 slips, the springs 162 maintain the followers 166 abutted against the respective cam surfaces 178. Therefore, as the outer ring 136 rotates, mating segments of the respective cam surfaces 178 apply a normal force N to the follower 166 and springs 162 along a line of action 176 parallel with the longitudinal axes 164 of the springs 162. Because the springs 162 bear against the base 160 of the respective pockets 154, the normal force N is also applied to the clutch driver 142 in a direction transverse to the rotational axis 179 of the clutch driver 142, imparting a moment to the clutch driver 142 and causing it to co-rotate with the outer ring 136. And, because the intermediate shaft 144 is coupled for co-rotation with the clutch driver 142, torque is transmitted to the intermediate shaft 144, which then drives the transmission 134 and the spindle 122 of the power tool 100.

However, when the reaction torque applied to the spindle 122 of the power tool 100 approaches the predetermined value at which the clutch mechanism 132 slips, the outer ring 136 begins to rotate relative to the clutch driver 142, causing the followers 166 to slide and/or roll along the respective cam surfaces 178 while being displaced along the line of action 176. As noted above, displacement of the followers 166 is constrained along the line of action 176 by the shape of the guide slots 172, 174 in the rear and front end caps 150, 152. While the followers 166 are gradually displaced into the pockets 154 and as the springs 162 gradually compress in a corresponding manner, the followers 166 gradually slide and/or roll from the respective cam surfaces 178 and transition into contact with the segments S1, causing the component of the normal force N resolved along the line of action 176, applied to the clutch driver 142 through each of the followers 166, to be quickly reduced to zero or a nominal value insufficient to impart a moment to the clutch driver 142 to cause its continued rotation. At this time, which may be considered a clutching event, the clutch driver 142, the intermediate shaft 144, the transmission 134, and the spindle 122 seize. But, continued activation of the motor 110 drives the outer ring 136 in a clockwise direction, causing it to slip (or continue rotation) relative to the clutch driver 142.

The outer ring 136 continues to rotate about the clutch driver 142 while the followers 166 slide and/or roll along the interior surface segments S1 until the followers 166 reach the next adjacent cam surface 178, at which time the compression springs 162 rebound and push the followers 166 onto the cam surfaces 178. If the reaction torque on the spindle 122 of the power tool 100 continues to remain above the predetermined value at which the clutch mechanism 132 slips, the outer ring 136 will continue to rotate relative to the clutch driver 142. However, if the reaction torque on the spindle 122 of the power tool 100 falls below the predetermined value at which the clutch mechanism 132 slips, upon the followers 166 re-engaging the mating segments of the respective cam surfaces 178, a normal force N is again applied to the followers 166 to impart a moment to the clutch driver 142 to cause it to rotate with the outer ring 136.

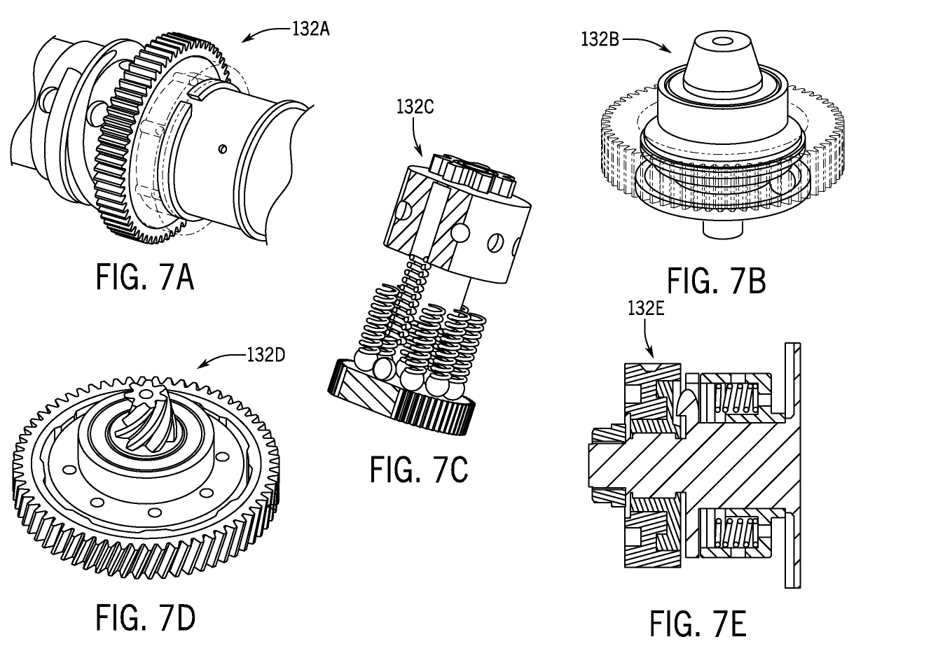

While one example of a mechanical clutch mechanism 132 is described above with references to FIGS. 3-6, the core drill 100 of some embodiments may include other types of mechanical clutch mechanisms. For example, FIGS. 7A-7E illustrate additional example clutch mechanisms 132A-132E, respectively, that may each be used in a core drill 100 of some embodiments. Clutch mechanisms 132 may vary in, for example, style, torque slip settings, operating speeds, life cycles, size, and/or other features. For example, the clutch mechanism 132 of FIGS. 3-6 as well as the clutch mechanism 132D of FIG. 7D may be considered radial ramp style clutch mechanisms. The clutch mechanisms 132A, 132B, and 132E of FIGS. 7A, 7B, AND 7E, respectively, may be considered axial ramp style clutch mechanisms. The clutch mechanism 132C of FIG. 7C may be considered an axial detent style clutch mechanism. Radial ramp style clutch mechanisms include mechanisms (such as springs 162 and followers 166) that travel along ramps (e.g., pockets 154) oriented in a radial direction with respect to the rotational axis of the clutch mechanism, whereas axial ramp style clutch mechanisms include mechanisms that travel along ramps oriented in an axial direction, and axial detent clutch mechanisms may utilize spring-loaded detent mechanisms that engage with a mating surface to transmit torque. In some embodiments, radial ramp style clutch mechanisms may have a static torque of approximately 10-15 N-m, operating speeds of approximately 2,700-4,800 rpm, and life cycle requirements of approximately 3,000-17,000 cycles. In some embodiments, axial ramp style clutch mechanisms may have a static torque of approximately 7-30 N-m, operating speeds of approximately 1,300-3,700 rpm, and life cycle requirements of approximately 4,000-6,750 cycles. In some embodiments, axial detent style clutch mechanisms may have a static torque of approximately 35 N-m and operating speeds of approximately 1,200-3,850 rpm. Additionally, other clutch mechanisms not specifically shown or described herein may be incorporated into the core drill 100 of some embodiments. Thus, while reference to a clutch mechanism 132 generally may be made throughout the present disclosure, the clutch mechanism 132 may correspond to any clutch mechanism 132, 132A-132E described herein or those not specifically described herein. Furthermore, in some embodiments, the core drill 100 may further include electronic clutch mechanisms in addition to the mechanical clutch mechanisms described above.

In view of the above, a clutch mechanism 132 can be provided on a core drill 100 to both prevent a bit, coupled to the spindle 122, from becoming stuck during application, and to allow torque to be applied when a bit is stuck to help it become unstuck. However, clutch mechanisms 132 may have a limited useful life and, when that life is exceeded, they may fail to transmit enough torque to the bit to complete an application. For example, clutch mechanisms 132 experience wear as a function of time clutching, and as a function of the driving speed of the core drill 100. As such, increasing bit speed to achieve greater performance in normal applications can lead to quicker degradation of the clutch mechanism 132.

Other approaches to addressing clutch life include changing the physical size of the clutch mechanism to increase its life, or slowing down the motor speed in all operating conditions. However, these alternative approaches have drawbacks. Increasing the physical size of the clutch mechanism adds weight and size to the power tool, which may be undesirable for handheld applications. Slowing down the motor speed in all conditions reduces the performance of the power tool during normal operation when clutching is not occurring.

Accordingly, in some embodiments, systems and methods may be provided to allow for increased bit speeds while maintaining the clutch life of a power tool, such as a core drill. This can allow for higher performance without the tradeoff of lower clutch life or requiring a larger or heavier clutch to meet the increased demand. For example, when the power tool detects a mechanical clutching event, the power tool can reduce its motor speed to preserve clutch life of the clutch mechanism. And once the clutching event ends, the motor can return to normal operating speed. In some embodiments, the power tool can implement a pre-trained Machine Learning (ML) model to detect when the power tool experiences a clutching event. The pre-trained ML model can make use of several sensors to achieve such detection, including, for example, sensors to detect current, voltage, speed, and/or vibration. Furthermore, in some embodiments, an acceleration sensor can detect when the clutch mechanism is actuating and use a threshold of acceleration or variation in the acceleration data, alone or in combination with other variables, to signify a clutching event.

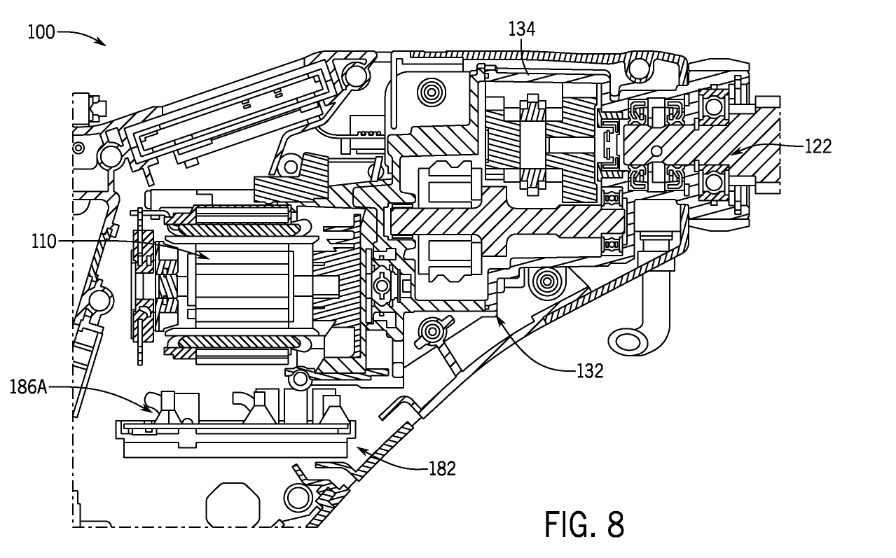

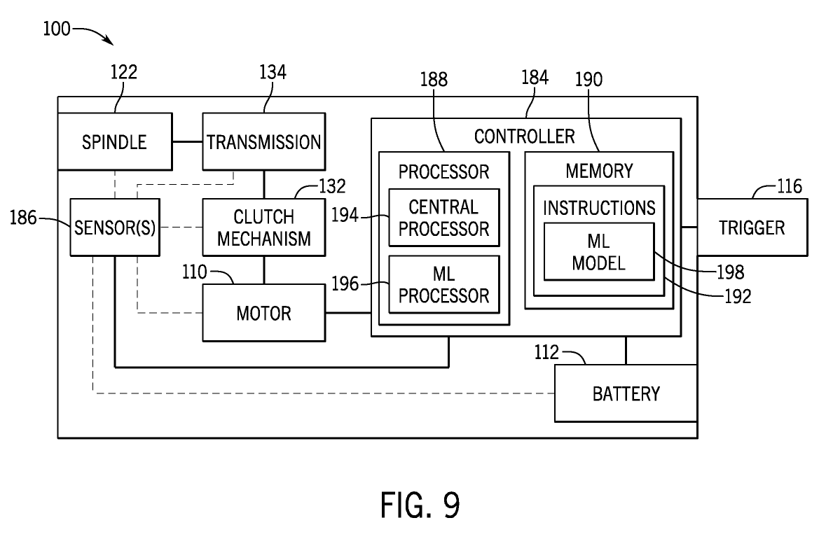

By way of example, FIG. 8 illustrates a partial cross-sectional view of a power tool 100, such as a core drill, and FIG. 9 illustrates a schematic view of the power tool 100. The power tool 100 of FIGS. 8 and 9 may include one or more features described above with respect to FIGS. 1-7E. For example, as shown in FIGS. 8 and 9, the power tool 100 can include a motor 110, a trigger 116 (shown in FIG. 9), a spindle 122, a clutch mechanism 132, a transmission 134, and a battery 112 (shown in FIG. 9). Additionally, the power tool 100 can include a printed circuit board assembly (PCBA) 182 (shown in FIG. 8) that includes a controller 184 (shown schematically in FIG. 9) and power electronics such as switching elements and the like for controlling operation of the power tool 100 and, more specifically, of the motor 110.

With reference still to FIGS. 8 and 9, one or more sensors 186 can also be housed on the PCBA 182 and/or at other locations within the tool housing 102. Such sensors 186 can include, for example, current sensors, voltage sensors, speed sensors, vibration sensors, acceleration sensors, and/or other sensors. While the sensors 186 are described as being housed on the PCBA 182 in some embodiments, in other embodiments, one or more sensors 186 may be disposed at other locations within the power tool 100. For example, an acceleration sensor may be mounted directly on or near the clutch mechanism 132, the transmission 134, the spindle 122, or the housing 102 of the power tool 100. In some embodiments, the power tool 100 may include multiple acceleration sensors disposed at different locations within the power tool 100, and the controller 184 may use inputs from one or more of the multiple acceleration sensors to detect a clutching event. In some embodiments, acceleration sensors can be combined in an inertial measurement unit (IMU) sensor 186a (shown in FIG. 8).

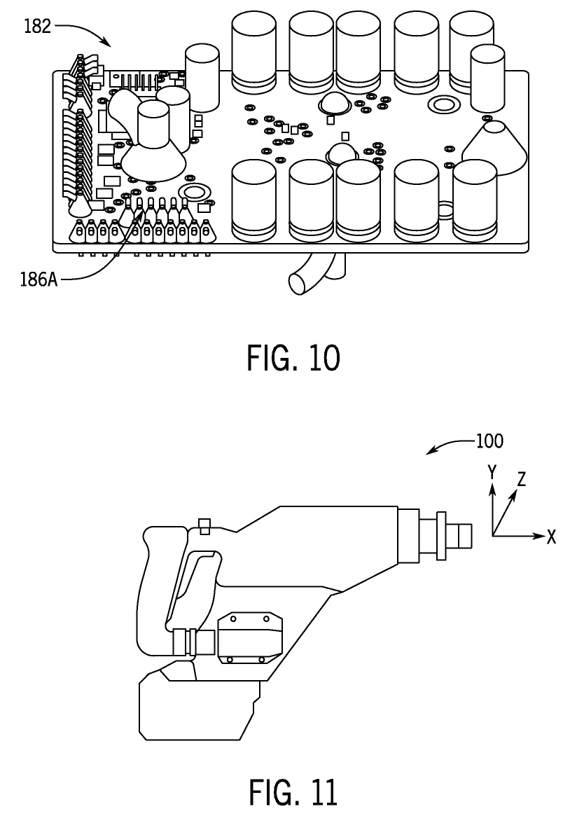

For example, FIG. 10 illustrates an example view of the PCBA 182 including the IMU sensor 186a, with reference to a top of the power tool 100 and a direction of the spindle 122. With this orientation, and with reference to FIG. 11, the controller 184 can obtain signals from the IMU sensor 186a to determine acceleration of the power tool 100 along an X-axis direction, a Y-axis direction, and/or a Z-axis direction. However, in some embodiments, single-axis accelerometers may instead be used to determine accelerations along the X-axis, Y-axis, and/or Z-axis. For example, the X-axis may be considered the “roll axis” or “bit axis” of the power tool 100, or the axis of rotation of the clutch mechanism 132, parallel to the axis of rotation 126 of the spindle 122. Accelerations in the Y- and Z-axes may correspond to the forces applied in a direction tangential to the axis of rotation 126 of the spindle 122. For example, with respect to radial ramp-style clutch mechanisms 132, accelerations in the Y- and Z-axes may relate to the forces applied from the followers 166 to the clutch driver 142 (e.g., as the springs 162 actuate in directions parallel to the Y- and/or Z-axes). On the other hand, with respect to axial ramp- and axial detent-style clutch mechanisms 132, accelerations in the X-axis may correspond to forces applied from spring-loaded mechanisms of the clutch mechanism 132.

In some embodiments, the power tool 100 may include other types of sensors for detecting clutching events. For example, a magnet may be coupled to the output shaft 130 or another rotating component downstream of the clutch mechanism 132, and a Hall effect sensor may monitor rotation of the magnet. In such embodiments, a clutching event may be detected when motor Hall sensors indicate that the motor 110 is rotating while the Hall effect sensor monitoring the output shaft 130 indicates that the output shaft 130 is stationary or rotating at a reduced speed. As another example, an inductive sensor may be positioned adjacent gear teeth of the output shaft 130 or another rotating component to detect rotation, and a clutching event may be similarly detected based on a difference between motor rotation and output shaft rotation. In some embodiments, a microphone or acoustic sensor may be used to detect clutching events, as clutching events may produce a distinct audible sound that can be recognized by the controller 184. In some embodiments, a strain gauge may be mounted on the housing 102, the transmission 134, or another structural component of the power tool 100 to sense changes in load, and a clutching event may be detected based on a change in strain indicative of a change in torque transmission through the clutch mechanism 132.

In some embodiments, the controller 184 can use inputs from the one or more sensors, such as acceleration inputs from the IMU sensor 186a, to control operation of the motor 110. More specifically, the controller 184 can include a processor 188 and memory 190. The memory 190 may include read-only memory (ROM), random access memory (RAM), other non-transitory computer-readable media, or a combination thereof. The memory 190 may include instructions 192 for the processor 188 to execute. The processor 188 may be configured to communicate with the memory 190 to store data and retrieve stored data. The processor 188 may be configured to receive the instructions 192 and data from the memory 190 and execute, among other things, the instructions 192. In some examples, through execution of the instructions 192 by the processor 188, the controller 184 may perform one or more of the methods described herein. For example, the instructions 192 may include software executable by the processor 188 to enable the controller 184 to, among other things, implement the various functions of the controller 184 described herein.

In some examples, the processor 188 includes one or more electronic processors. For example, as illustrated, the processor 188 may include a central processor 194 and a machine learning (ML) processor 196. In other examples, the functions of the processors 194 and 196 are combined into a single processor or further distributed among additional processors. As illustrated, the instructions 192 include a machine learning (ML) model 198. The ML model 198 may be a pre-trained machine learning model (e.g., a decision tree, a scalable distributed gradient-boosted decision tree (GBDT), a neural network, convolutional neural network (CNN), recurrent neural network (RNN)) that is executed by the processor 188. In some examples, the ML model 198, as a trained machine learning model, may be referred to as a classifier that, when executed, receives an input, processes the input to classify the input, and outputs a classification corresponding to the input (e.g., selected from a finite set of potential classifications). Generally, the output classification may be the classification from the set of potential classifications that best corresponds to the input. In some examples, the ML processor 196 may execute the ML model 198 to perform clutch event detection, as described herein. In other words, the ML processor 196 may serve as a dedicated processor to execute the ML model 198 to determine when the power tool 100 experiences a clutching event, as described herein. In such examples, the central processor 194 may perform other control for the power tool 100, such as, for example, enabling, disabling, or adjusting a speed of the motor 110.

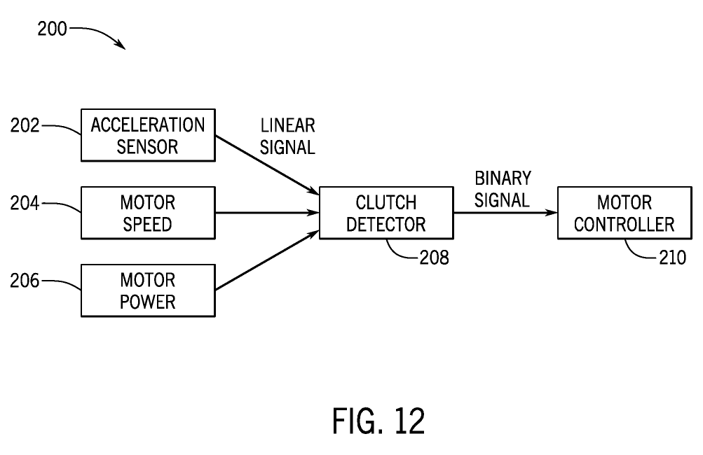

Accordingly, FIG. 12 illustrates an example flow diagram 200 of operation of the power tool 100. That is, the controller 184 can obtain inputs from one or more sensors 186, such as an acceleration sensor input 202 (e.g., in the X-axis, the Y-axis, and/or the Z-axis), a motor speed input 204, and/or a motor power input 206, and/or other inputs. In some embodiments, only an acceleration tangential to the rotational axis 126 of the spindle 122 is used as the acceleration sensor input 202 (such as Y- and/or Z-axis acceleration inputs). In some embodiments, only the X-axis acceleration is used as an acceleration sensor input 202. In other examples, X-, Y-, and/or Z-axis acceleration inputs are used in a particular combination as the acceleration sensor input 202. In some embodiments, the selection of which acceleration axis or axes to use as inputs can be changed or configured based on the type or design of the clutch mechanism 132 used in the power tool 100. In some embodiments, these inputs correspond directly to acceleration, speed, and power, respectively. In some embodiments, one or more of these inputs may additionally or alternatively correspond to rates of change of acceleration, speed, and/or power. In some embodiments, the controller 184 may additionally obtain other inputs for use in clutch event detection, such as motor current, motor voltage, motor temperature, battery state of charge or discharge rate, spindle speed measured independently from motor speed (e.g., downstream of the transmission 134), torque sensor inputs, audio or acoustic inputs, and/or user inputs such as trigger position or grip force.

Referring still to FIG. 12, these inputs 202-206 can be linear signals to a clutch detector 208. In some embodiments, the clutch detector 208 may be implemented by one or more of the processor 188, the central processor 194, and the ML processor 196, which executes instructions 192 to use the linear signals with one or more algorithms and/or thresholds to determine a clutch event. For example, if one or more of the linear signals is above (or below) a set threshold, a clutch event may be detected. That is, if acceleration, speed, and/or power (and/or rates of change of acceleration, speed, and/or power) exceed a threshold, a clutch event may be detected. As another example, the linear signals are collectively input into an algorithm, and if the output of the algorithm is above (or below) a set threshold, a clutch event may be detected. In other embodiments, the clutch detector 208 is the ML processor 196, which executes the ML model 198 using the linear signals to determine a clutch event. The output of the clutch detector 208 may be a binary signal to a motor controller 210, e.g., a processor 188 that executes instructions 192 to control a speed of the motor 110. For example, upon receiving a first signal indicating a clutch event is being detected, the motor controller 210 can reduce a speed of the motor 110 to a preset “reduced speed” (e.g., a reduced speed, in RPM (rotations per minute), stored in memory 190). Upon receiving a second signal indicating no clutch event is being detected, the motor controller 210 can return the speed of the motor 110 to a previous “normal” operating speed, such as the previous speed set prior to the clutch event being detected, a maximum operating speed, or a motor speed corresponding to distance of trigger pull 116.

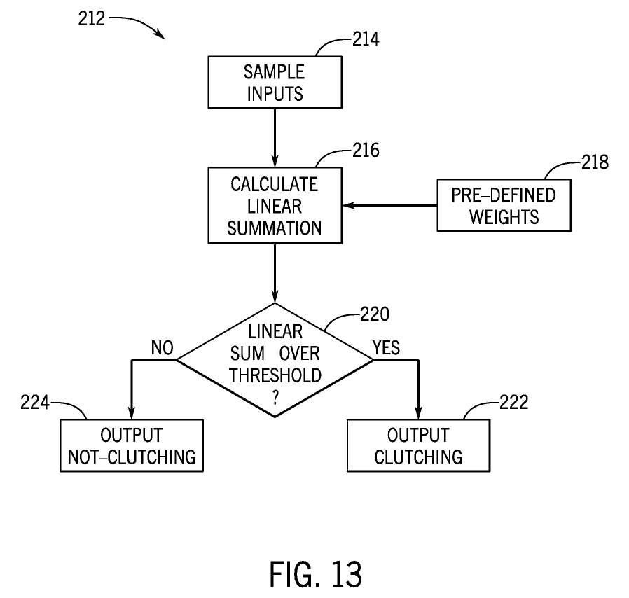

Furthermore, FIG. 13 illustrates an example method 212 of detecting a clutch event according to some embodiments. At step 214 sample inputs, such as an acceleration sensor input (e.g., in the X-axis, the Y-axis, and/or the Z-axis), a motor speed input, a motor power input, and/or other inputs can be input to the ML model 198. At step 216, the ML processor 196 can execute the ML model 198 to calculate a linear summation of the sample inputs and pre-defined weights that are input at step 218. In some embodiments, the pre-defined weights can be set based on a type of clutch mechanism 132 used in the power tool 100. For example, in some applications, such as with radial ramp-style clutch mechanisms, Y-axis and/or Z-axis accelerations may be used as the acceleration sensor input. Alternatively, in such applications, X-axis accelerations may further be used as the acceleration sensor input, though weighted less than Y-axis or Z-axis accelerations. As another example, in some applications, such as with axial ramp-style clutch mechanisms, X-axis accelerations may be weighted more than Y-axis or Z-axis accelerations.

Referring still to FIG. 13, at step 220, the ML processor 196 can determine whether the linear summation is above a threshold. If so, the ML processor 196 outputs that a clutching event is being detected at step 222. If not, the ML processor 196 outputs that a clutching event is not being detected at step 224. For example, steps 222 and 224 can correspond to binary outputs (e.g., 1 = YES predicting clutch event and 0 = NOT predicting clutch event, or vice versa) to the motor controller 210 as discussed above with respect to FIG. 12. In some embodiments, in addition to or instead of reducing the speed of the motor 110 upon detection of a clutching event, the controller 184 may take other actions in response to detecting a clutching event, such as briefly reversing a direction of the motor 110 to relieve torque, applying an electronic brake, providing haptic feedback to the user (e.g., a vibration alert), providing an audible or visual alert (e.g., via an LED or buzzer), logging the clutch event for maintenance tracking or clutch life estimation, adjusting a clutch torque threshold of an electronic clutch mechanism, and/or disabling or reducing operation of a dust extraction system.

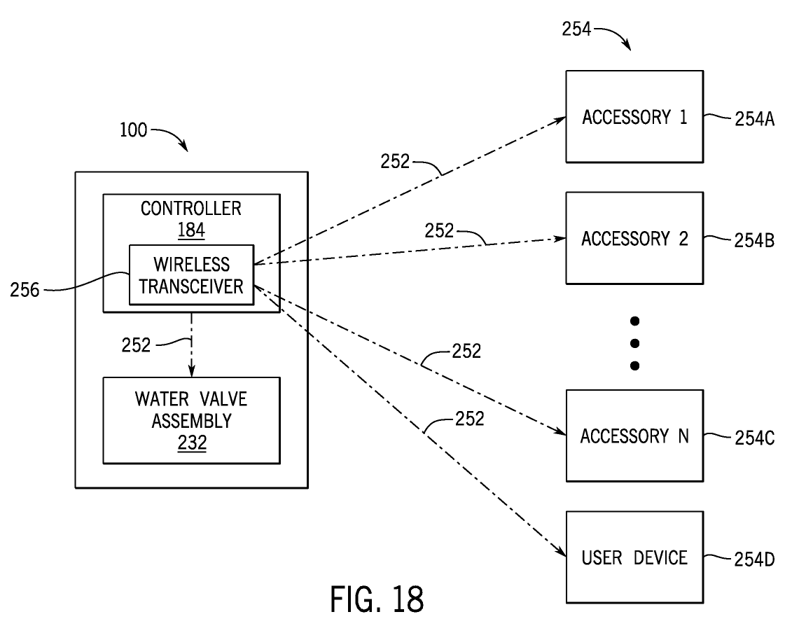

For example, in some embodiments, the controller 184 may log clutch event data to memory 190 for use in estimating clutch wear or remaining clutch life. More specifically, in some examples, the controller 184 may accumulate a total clutching time or a count of clutching events over the life of the power tool 100, and may compare the accumulated value to a predetermined threshold. When the accumulated clutching time or count exceeds the threshold, the controller 184 may activate a user-facing indicator, such as an LED or display message, to inform the user that the clutch mechanism 132 may require service or replacement. In some embodiments, the logged clutch event data may be accessible to the user via a wireless communication interface, such as via a wireless transceiver 256 (shown in FIG. 18) using a Bluetooth or Wi-Fi connection to a user device 254D (shown in FIG. 18) or tool management system. For example, the user may view clutch wear information, accumulated clutching time, or estimated remaining clutch life through a companion application or cloud-based tool management platform. In some embodiments, the wireless communication interface may also allow the logged data to be transmitted to a service provider or manufacturer for remote diagnostics or predictive maintenance purposes.

Furthermore, in some embodiments, the controller 184 may limit or reduce a maximum operating speed of the motor 110 based on accumulated clutching time or clutch wear. For example, if the accumulated clutching time or count of clutching events exceeds a predetermined threshold indicative of a worn clutch mechanism 132, the controller 184 may reduce the maximum allowable motor speed to extend the remaining useful life of the clutch mechanism 132 before total failure. In some embodiments, the controller 184 may progressively reduce the maximum motor speed as the accumulated clutching time increases, such as by implementing multiple speed limit thresholds corresponding to different levels of clutch wear. By limiting the output speed when the clutch mechanism 132 is worn, the power tool 100 may continue to operate at reduced performance rather than experiencing complete clutch failure, thereby providing additional useful life to the user before service or replacement is required.

While the clutch detector 208 is described above as using a machine learning model 198 or threshold-based algorithms to detect clutching events, in other embodiments, the clutch detector 208 may use other detection approaches. For example, the clutch detector 208 may perform frequency-domain analysis on the acceleration sensor input 202, such as by applying a Fast Fourier Transform (FFT) to detect frequency signatures characteristic of clutch slip events. In some embodiments, the clutch detector 208 may use adaptive thresholds that change over time based on clutch wear, operating conditions, or historical clutch event data. For example, as the clutch mechanism 132 wears over its useful life, the acceleration signatures associated with clutching events may change, and the clutch detector 208 may adjust its detection thresholds or model parameters accordingly. In some embodiments, the clutch detector 208 may use an ensemble approach that combines a machine learning model with one or more rule-based algorithms, such that the outputs of the machine learning model and the rule-based algorithms are combined to determine whether a clutching event is occurring. In some embodiments, the clutch detector 208 may be implemented locally on the controller 184 within the power tool 100 (i.e., edge-deployed inference). In other embodiments, sensor data from the power tool 100 may be transmitted to a remote server or cloud-based computing system for clutch event analysis, and the results may be communicated back to the controller 184 to control the motor 110 and/or the water valve assembly 232.

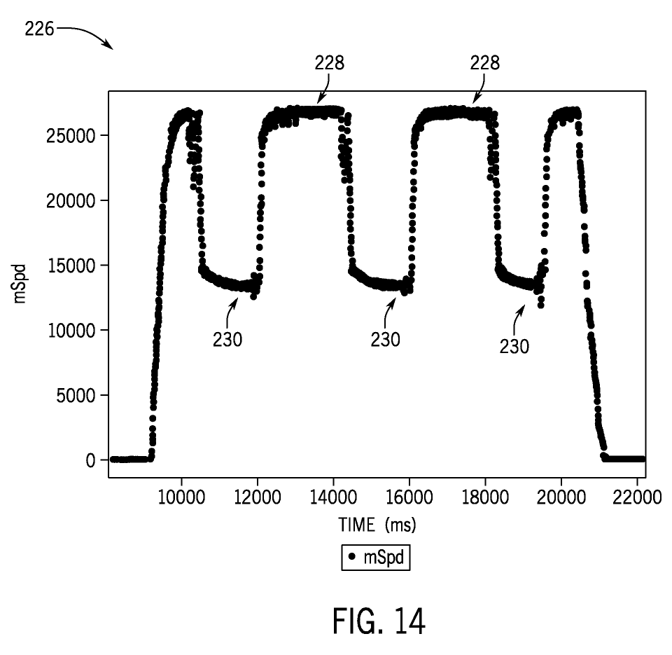

By way of example, FIG. 14 illustrates a graph 226 of motor speed versus time during operation of a power tool 100. As shown in FIG. 14, motor speed oscillates between a maximum, or full operating speed 228 when no clutch events are detected, and a reduced speed 230 when clutching events are detected. While the reduced speed 230 shown in FIG. 14 is above zero, in other examples, the reduced speed 230 may be set to zero to completely stop the motor, or to another speed.

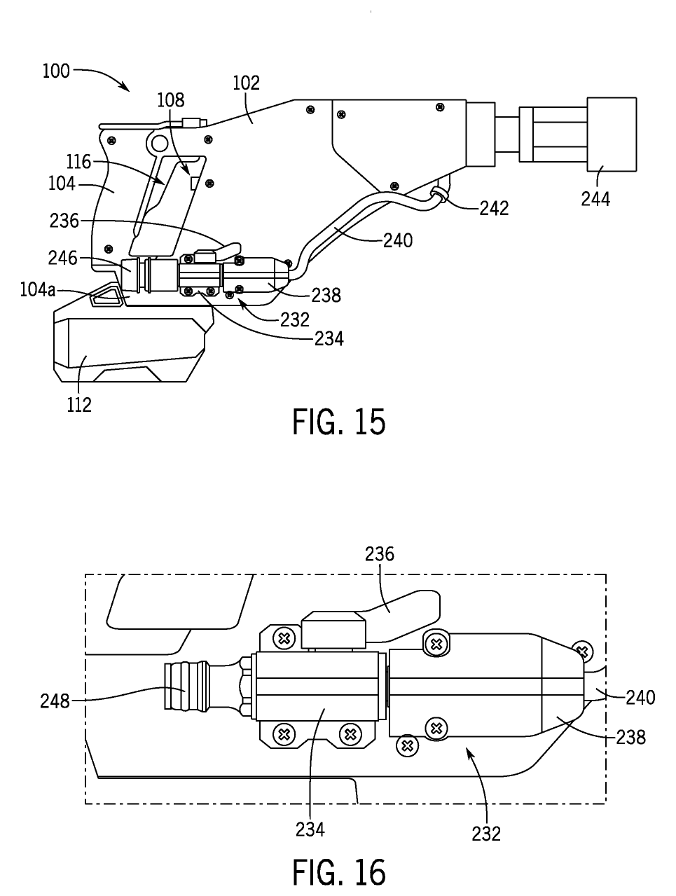

Referring now to FIGS. 15 and 16, in some examples, the core drill 100 may further include a water valve assembly 232 configured to control a flow of water to a drilling spindle and a cutting bit. FIG. 15 illustrates a partial internal view of another example core drill 100, which may include similar components as that described above with respect to the core drill 100 of FIG. 1. As shown in FIG. 15, the water valve assembly 232 may be disposed within the housing 102 adjacent a front end of the core drill 100 and can control a flow of water from a water supply line (not shown) to the spindle 122 and a cutting bit coupled thereto. The water valve assembly 232 may include a valve body 234 comprising a valve (not shown), a manually operable actuator 236, and an electrically actuated actuator 238 for selectively opening and closing the valve within the valve body 234.

Generally, the water valve assembly 232 is configured to supply water to the spindle 122 and a cutting bit coupled thereto to lubricate and cool the cutting bit during cutting operations. In some embodiments, the electrically actuated actuator 238 includes a solenoid that is configured to selectively open the valve in response to actuation of the trigger 116 and close the valve when the trigger 116 is released. Additionally, the manually operable actuator 236 may comprise a lever that allows a user to manually open or close the valve.

During operation, water may enter the water valve assembly 232 through a water inlet 248 adjacent the valve body 234 (shown in FIG. 16), pass through the valve body 234 when the valve is open, and flow through a conduit 240 extending from the water valve assembly 232 along the housing 102. A water supply coupling 246 may be disposed over the water inlet 248 for connecting an external water supply to the water valve assembly 232. A fluid connector 242 may be disposed at the front of the core drill 100 where the spindle 122 extends from the housing 102, and a water coupling 244 may be coupled to the distal end 124 of the spindle 122 to deliver water to the cutting bit. In some embodiments, the water coupling 244 is disposed over and coaxial with the spindle 122. In some embodiments, water may pass through a gearbox or transmission 134 of the core drill 100 to reach the center of the cutting bit, aiding in the removal of stone material from the cored hole.

According to some examples, the controller 184 may control the water valve assembly 232 based on the clutch event detection described above with respect to FIGS. 12 and 13. When the clutch detector 208 detects a clutching event, the controller 184 may deactivate the water valve assembly 232, such as by closing the valve via the electrically actuated actuator 238, to stop the flow of water to the cutting bit during the clutching event. In other words, upon detection of a clutching event, the controller 184 outputs a clutch event signal to the water valve assembly 232 that causes the valve to be closed (i.e., deactivates the water valve assembly 232). In some embodiments, the controller 184 may also or alternatively output the clutch event signal to external accessories, as further described below.

When the clutch detector 208 determines that the clutching event has ended, the controller 184 may reactivate the water valve assembly 232, such as by opening the valve via the electrically actuated actuator 238, to resume the flow of water to the cutting bit. In some embodiments, the controller 184 may deactivate the water valve assembly 232 in addition to reducing the speed of the motor 110 during the clutching event. In other embodiments, the controller 184 may deactivate the water valve assembly 232 without reducing the speed of the motor 110. In some embodiments, operation of the manually operable actuator 236 may override or operate independently of control of the water valve assembly 232 by the controller 184. Furthermore, in some embodiments, control of the water valve assembly 232 based on clutch event detection may be implemented in addition to, and not as a replacement for, trigger-based control of the water valve assembly 232. For example, the water valve assembly 232 may be modulated by both the trigger 116 position (e.g., opening the valve when the trigger 116 is depressed and closing the valve when the trigger 116 is released) and by the clutch event detection system, such as by closing the valve during a detected clutching event even when the trigger 116 remains depressed. In this manner, the clutch-based water valve control may operate as an additional layer of control on top of the trigger-based control.

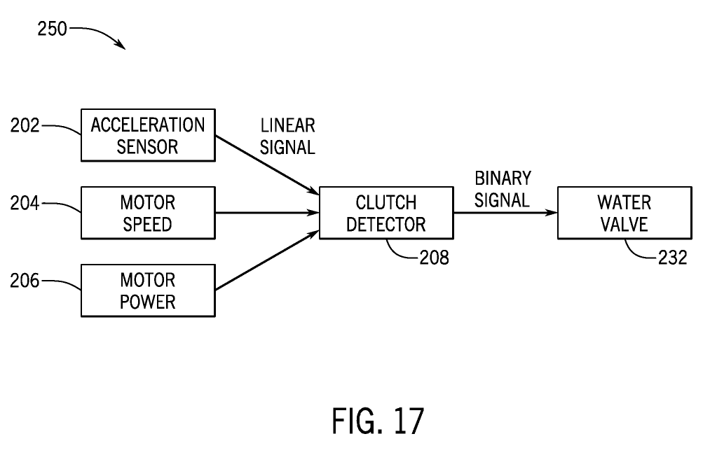

By way of example, FIG. 17 illustrates a control architecture 250, similar to that shown in FIG. 12, but in which an output of the clutch detector 208 is provided to the controller 184 for control of the water valve assembly 232 rather than, or in addition to, control of the motor 110. As shown, acceleration inputs, motor speed inputs, and motor power inputs may be provided as linear signals to the clutch detector 208. The clutch detector 208 may output a binary signal indicative of a clutching event, which the controller 184 may use to deactivate or modulate the water valve assembly 232 as described herein.

During a clutching event, the clutch mechanism 132 may exert large vibrations, which can cause water flowing through the gearbox or transmission 134 to leak into greased cavities or bearings within the driveline, thereby degrading lubricant and reducing the life of driveline components. By deactivating the water valve assembly 232 during the clutching event, water ingress into the driveline may be reduced, which may increase lubricant and driveline life while maintaining the performance of the core drill 100. In some embodiments, deactivating the water valve assembly 232 during a clutching event may also prevent unnecessary water flow when the cutting bit has stopped or slowed, which may reduce water waste and avoid water pooling at the workpiece. Other approaches to addressing driveline life in the presence of water flow include increasing a physical size of the driveline to improve durability or adding additional seals to inhibit water ingress. However, increasing the physical size of the driveline may add weight and bulk to the power tool, and adding additional seals may reduce nominal operating efficiency of the driveline.

In some embodiments, rather than fully deactivating the water valve assembly 232 during a clutching event, the controller 184 may reduce a flow rate of water through the water valve assembly 232. For example, the controller 184 may partially close the valve via the electrically actuated actuator 238 or control a proportional valve within the water valve assembly 232. In some embodiments, the controller 184 may gradually close the valve rather than abruptly closing the valve, such as to mitigate pressure surges or water hammer effects in the conduit 240 or other portions of the water supply system. For example, the electrically actuated actuator 238 may be controlled to close the valve over a predetermined time period to reduce a rate of change of water flow and thereby reduce pressure transients.

In some embodiments, the controller 184 may implement delays or debounce logic when activating or deactivating the water valve assembly 232 in response to a clutching event. For example, the controller 184 may wait a predetermined delay period after detecting a clutching event before deactivating or reducing flow through the water valve assembly 232, such as to confirm that the clutching event is sustained and avoid unnecessary response to transient or momentary clutch detections. Similarly, the controller 184 may wait a predetermined delay period after the clutching event has ended before reactivating or increasing flow through the water valve assembly 232, such as to confirm that the clutching event has truly ended and to avoid rapid cycling of the valve. In some embodiments, such behavior may be implemented by requiring the clutch detector 208 to continuously indicate a clutching event, or an absence of a clutching event, for a predetermined debounce period before a corresponding change in valve state is performed.

While the electrically actuated actuator 238 is described in some embodiments as including a solenoid, in other embodiments the electrically actuated actuator 238 may include a motorized valve, a pneumatic actuator, a piezoelectric actuator, or another electrically controllable valve actuator. Additionally or alternatively, in some embodiments, the controller 184 may control a water pump (not shown) to stop or reduce water delivery to the cutting bit during the clutching event, rather than or in addition to controlling the water valve assembly 232.

In some embodiments, the water valve assembly 232 may be disposed at different locations along the water delivery path. For example, the water valve assembly 232 may be disposed upstream of the power tool 100, such as at a water supply source or hose connection, within the housing 102 of the power tool 100 as illustrated in FIGS. 15 and 16, or near or within a cutting bit assembly coupled to the spindle 122. In some embodiments, the power tool 100 may include multiple valves distributed along the water delivery path, such as a coarse upstream shutoff valve and a fine downstream modulation valve. In some embodiments, rather than stopping water flow during a clutching event, the controller 184 may divert water flow to a bypass conduit, such as to cool another component of the power tool 100 (e.g., the motor 110, the clutch mechanism 132, or the transmission 134), or may recirculate water through a recirculation loop during the clutching event.

In some embodiments, the water valve assembly 232 may have a normally-open configuration in which the valve is biased open and is closed by the controller 184 during a clutching event. In other embodiments, the water valve assembly 232 may have a normally-closed configuration in which the valve is biased closed and is opened by the controller 184 during normal cutting operations. The selection of a normally-open or normally-closed configuration may be based on a desired fail-safe behavior, such as maintaining water flow for dust suppression or preventing water flow to avoid water damage. In some embodiments, the controller 184 may default the water valve assembly 232 to an open or closed state upon detection of a fault or loss of a clutch event signal, based on a desired safety, reliability, or dust-suppression priority.

In some embodiments, water flow to the cutting bit may be controlled by mechanisms other than or in addition to a valve. For example, the controller 184 may control an adjustable orifice, a pinch-tube flow restrictor, or another variable restriction element to modulate water flow during a clutching event. In some embodiments, the controller 184 may control a variable-speed water pump to modulate water delivery based on clutch event detection, such as by reducing a pump speed or modulating a pump duty cycle during the clutching event.

In some embodiments, the controller 184 may implement multi-threshold logic for controlling the water valve assembly 232 based on a severity or duration of the clutching event. For example, the controller 184 may control the water valve assembly 232 to reduce the flow rate of water through the water valve assembly 232 in response to a brief or intermittent clutching event, and may fully deactivate the water valve assembly 232 in response to a sustained or extended clutching event. In some embodiments, the controller 184 may progressively reduce the flow rate of water as the duration of the clutching event increases.

In some embodiments, the controller 184 may control the water valve assembly 232 according to a clutch-dependent control profile rather than simply opening or closing the valve. For example, the controller 184 may temporarily pulse the valve closed during a clutching event using duty-cycle control, or may reduce effective water flow by alternating between open and closed states over a control interval. In some embodiments, the controller 184 may apply different valve behaviors depending on a duration, frequency, or severity of the clutching event. For example, the controller 184 may maintain a reduced flow rate during intermittent or low-severity clutching events, and may fully close the valve during sustained or high-severity clutching events.

In some embodiments, the timing of water valve control relative to the clutching event may vary. For example, the controller 184 may initiate water flow reduction before full clutch disengagement in an anticipatory manner, substantially simultaneously with detection of the clutching event, or only after the clutching event exceeds a threshold duration. Similarly, restoration of water flow after the clutching event may be delayed, staged (e.g., from partial flow to full flow), or conditional on another parameter such as torque recovery or motor speed returning to a normal operating range.

Though clutching events are described above as being detected using acceleration inputs, motor power, and motor speed with respect to FIGS. 12 and 13, in some embodiments, the controller 184 may deactivate or modulate the water valve assembly 232 based on clutch event signals derived from different sources or detection techniques, such as the alternative sensing methods described above (e.g., Hall effect sensors, inductive sensors, microphones, or strain gauges). For example, the controller 184 may control the water valve assembly 232 based on direct clutch sensor signals, such as from the acceleration sensor input 202, or based on inferred clutching determined from motor current, speed differential, torque estimation, or other controller state information. In some embodiments, the controller 184 may control the water valve assembly 232 based on a software-based clutch state, such as a clutch-active flag asserted by firmware of the controller 184 in response to one or more of the above inputs.

In view of the above, in some embodiments, the controller 184 may control the speed of the motor 110 based on clutch event detection, as described with respect to FIG. 12. Additionally or alternatively, upon detecting a clutching event, the controller 184 may output a clutch event signal. The clutch event signal may be transmitted to an accessory in communication with the controller 184 to deactivate the accessory. For example, the accessory may be the water valve assembly 232 as described with respect to FIG. 17, or one or more external accessories or systems, where the clutch event signal is transmitted to deactivate the accessory. The controller 184 may also output the clutch event signal to a user device such as a mobile phone or tablet.

By way of example, FIG. 18 illustrates a schematic view of a communication pathways between the power tool 100 and various accessories. The controller 184 may communicate a clutch event signal 252 internally to the water valve assembly 232. The controller 184 may also communicate the clutch event signal 252 to one or more external accessories 254 via a wired connection or a wireless communication interface, such as through wireless transceiver 256. For example, the controller 184 may transmit the clutch event signal 252 to a motor-driven core stand 254A indicating that a clutching event has occurred, such that the core stand may pause or stop feeding the core drill 100 until the clutching event has ended and the drill is able to resume normal operation. Similarly, the controller 184 may transmit the clutch event signal 252 to a vacuum pump 254B to deactivate the vacuum pump, or to a robotic coring machine 254C to deactivate or pause the robotic coring machine. As a result, the power tool 184 can coordinate operation of such accessories 254 based on the clutching state of the power tool 100. In some embodiments, the clutch event signals 252 may not only indicate when a clutching event begins so as to trigger deactivation of the accessory, but also when a clutching event ends so as to trigger reactivation of the accessory, and/or may further include accumulated clutch data such as total clutching time or clutch wear estimates. In some embodiments, the clutch event signal 252 may also be communicated to a user device 254D such as a mobile phone or tablet via a wireless communication interface, for example to provide real-time alerts or notifications to the user regarding clutching events through a companion application.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phrase “and/or” used with two or more items is intended to cover the items individually and both items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool comprising:
a motor including a motor output shaft;
a spindle driven by the motor output shaft to rotate about an axis;
a clutch mechanism positioned between the motor and a distal end of the spindle, the clutch mechanism to execute a clutching event to limit an amount of torque transmitted from the motor output shaft to the spindle when the torque reaches a torque threshold;
a sensor that detects an acceleration of the power tool; and
a controller to:
control a speed of the motor,
obtain acceleration inputs from the sensor,
detect the clutch mechanism executing the clutching event using the acceleration inputs, a power of the motor, and the speed of the motor, and
reduce the speed of the motor when the clutching event is detected.

2. The power tool of claim 1, wherein the controller is to detect the clutch mechanism executing the clutching event using the acceleration inputs, the power of the motor, and the speed of the motor with a machine learning model.

3. The power tool of claim 2, further comprising an additional sensor that detects an acceleration in a direction parallel to the axis, wherein the acceleration inputs are from the sensor and the additional sensor.

4. The power tool of claim 1, wherein the controller is to reduce the speed of the motor to zero rotations per minute.

5. The power tool of claim 1, wherein the controller is to reduce the speed of the motor to a reduced speed above zero rotations per minute.

6. The power tool of claim 1, wherein the sensor is an inertial measurement unit.

7. The power tool of claim 6, further comprising:
a housing that houses the motor and the clutch mechanism; and
a printed circuit board assembly housed within the housing, wherein the inertial measurement unit is located on the printed circuit board assembly.

8. The power tool of claim 1, wherein the sensor detects a linear acceleration in a direction tangential to the axis.

9. The power tool of claim 1, wherein the sensor detects a linear acceleration in a direction parallel to the axis.

10. The power tool of claim 1, further comprising a water valve assembly configured to control a flow of water to a drill bit coupled to the spindle, wherein the controller is further to deactivate the water valve assembly to stop the flow of water to the drill bit when the clutching event is detected.

11. A method of operating a power tool, the method comprising:
operating a motor of the power tool at an operating speed;
obtaining sensor inputs from an acceleration sensor located within the power tool;
determining when a mechanical clutch mechanism of the power tool is executing a clutching event based on the sensor inputs; and
operating the motor of the power tool at a reduced speed below the operating speed when the mechanical clutch mechanism of the power tool is executing the clutching event.

12. The method of claim 11, further comprising:
determining when the mechanical clutch mechanism of the power tool is no longer executing the clutching event based on the sensor inputs; and
operating the motor of the power tool back at the operating speed when the mechanical clutch mechanism of the power tool is no longer executing the clutching event.

13. The method of claim 11, wherein determining when the mechanical clutch mechanism of the power tool is executing the clutching event based on the sensor inputs further includes basing the determining on a power of the motor and the operating speed.

14. The method of claim 13, wherein determining when the mechanical clutch mechanism of the power tool is executing the clutching event based on the sensor inputs, the power of the motor, and the operating speed further includes using a machine learning model that receives as inputs the sensor inputs, the power of the motor, and the operating speed, and outputs a clutching event determination.

15. The method of claim 11, wherein the sensor inputs from the acceleration sensor correspond to linear accelerations tangential to a rotation axis of a spindle of the power tool.

16. The method of claim 11, wherein the sensor inputs from the acceleration sensor correspond to linear accelerations parallel to a rotation axis of a spindle of the power tool.

17. A power tool comprising:
a motor including a motor output shaft;
a spindle driven by the motor output shaft to rotate about an axis;
a clutch mechanism positioned between the motor and a distal end of the spindle, the clutch mechanism to execute a clutching event to limit an amount of torque transmitted from the motor output shaft to the spindle when the torque reaches a torque threshold;
and
a controller to:
detect the clutch mechanism executing the clutching event, and
transmit a clutch event signal to an accessory in communication with the controller to deactivate the accessory.

18. The power tool of claim 17, wherein the accessory is a water valve assembly configured to control a flow of water to a drill bit coupled to the spindle; and wherein the controller is to transmit the clutch event signal to the water valve assembly to deactivate the water valve assembly to stop the flow of water to the drill bit.

19. The power tool of claim 17, wherein the accessory is one of a motor-driven core stand, a vacuum pump, a dust extraction system, or a robotic coring machine.

20. The power tool of claim 17, wherein the controller is further to reduce a speed of the motor when the clutching event is detected.
